(19) United States
(12) Patent Application Publication
(10) Pub. No.: US 2014/0042054 A1
(43) Pub. Date: Feb. 13, 2014

(54) CARRYING CASE WITH INTEGRATED WHITEBOARD

(71) Applicant: Walter L. Jones, JR., Coto De Caza, CA (US)

(72) Inventor: Walter L. Jones, JR., Coto De Caza, CA (US)

(21) Appl. No.: 13/568,854

(22) Filed: Aug. 7, 2012

(51) Int. Cl. B43L 1/00; B65D 25/28; B65D 25/34

(52) U.S. Cl. 206/573; 206/232

(57) ABSTRACT

A carrying case includes a first panel which has a first panel outer surface and a first panel inner surface, where the first panel outer surface displays an image on a whiteboard material. The carrying case includes a second panel comprising a second panel outer surface and a second panel inner surface. The carrying case further includes at least one hinge rotatably coupling the first panel to the second panel along an axis, where the hinge is configured to allow the first panel and the second panel to fold close and couple the first panel inner surface to the second panel inner surface.

### BACKGROUND OF THE INVENTION

1. Field of the Invention

The present invention relates to a carrying case.

2. Description of the Related Art

Whiteboards allow dry erase markers to be used to mark the surface of the whiteboard. Whiteboards provide great versatility with an erasable medium that avoids the environmental waste caused by paper. Whiteboards allow a user to write and erase repeatedly without the inconvenience and costs of buying new sheets of paper and disposing used paper. Whiteboards assist teachers in visually communicating educational materials to their students. In the field of athletic sports, Coaches use whiteboards to quickly and conveniently depict specific plays to the team. Player positions, movements, and roles may be easily drawn onto a whiteboard. Certain whiteboards designed for coaches of specific sports such as basketball, football, soccer, and hockey contain a surface with an image of a specific court for that sport. In many cases, a user will need to carry a number of accessories in conjunction with the whiteboard such as dry erase markers of various colors, notepads, and pens.

Therefore, there is a need for a carrying case to provide coaches, teachers, and other users with a whiteboard that also features storage options to enhance both functionality and ease of use.

### BRIEF SUMMARY OF THE INVENTION

One or more embodiments of the invention enable a carrying case with an integrated whiteboard. In some exemplary embodiments of the present invention, a carrying case includes a first panel which has a first panel outer surface and a first panel inner surface, where the first panel outer surface displays an image on a whiteboard material. The carrying case includes a second panel comprising a second panel outer surface and a second panel inner surface. The carrying case further includes at least one hinge rotatably coupling the first panel to the second panel along an axis, where the hinge is configured to allow the first panel and the second panel to fold close and couple the first panel inner surface to the second panel inner surface.

In some embodiments of a carrying case, the second panel outer surface displays a second image on a second whiteboard material.

Some embodiments of a carrying case include a transparent sheet coupled over the first panel outer surface. The transparent sheet is configured to allow a dry erase marker to create marks upon it.

In some embodiments of a carrying case, the first panel inner surface and the second panel inner surface are configured to create storage compartments when the first panel and the second panel are folded closed.

In some embodiments of a carrying case, the first panel has a first handle cavity and the second panel has a second handle cavity. The first handle cavity may have substantially identical dimensions as the second handle cavity.

In some embodiments of a carrying case, the first panel has a vertically extending border with an outer layer and an inner layer, where the first panel outer layer and the first panel inner layer have different heights. The second panel may also have a vertically extending border with an outer layer and an inner layer, where the second panel outer layer and the second panel inner layer have different heights. In some embodiments, the first panel outer layer and the second panel inner layer are configured to overlap when the first panel and the second panel are folded closed. There, the first panel inner layer and the second panel outer layer are also configured to overlap when the first panel and second panel are folded closed.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates an exemplary embodiment of a carrying case in a folded closed position;

FIG. 2 illustrates an exemplary embodiment of a carrying case between a folded closed position and a folded open position;

FIG. 3 illustrates a hinge on an exemplary embodiment of a carrying case.

### DETAILED DESCRIPTION

A carrying case with an integrated whiteboard will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

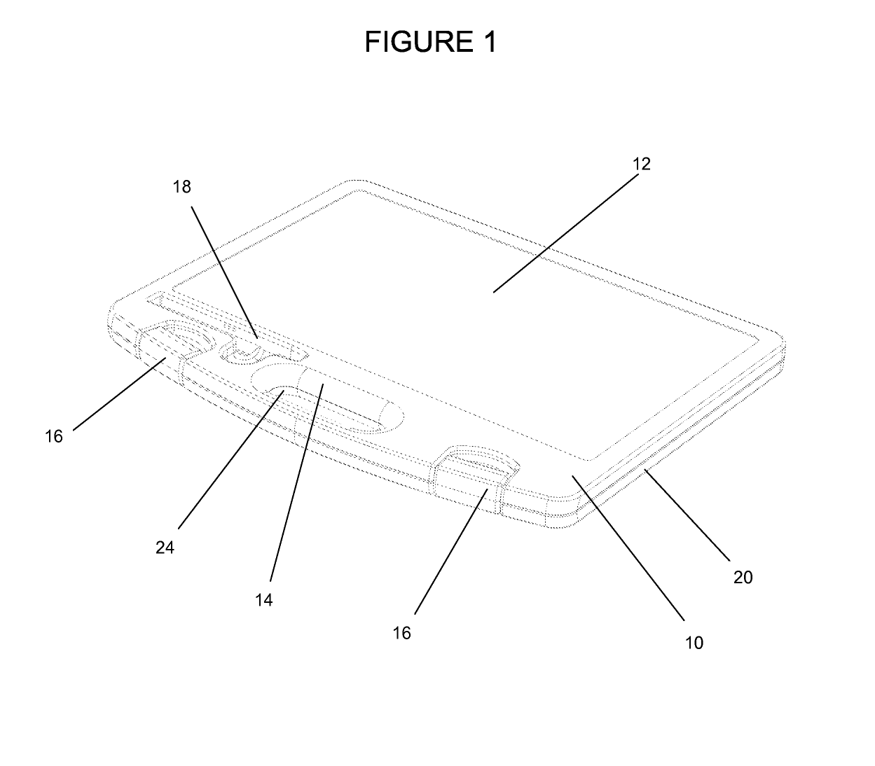

FIG. 1 illustrates an exemplary embodiment of a carrying case in a folded closed position. The carrying case comprises a first panel 10 and a second panel 20. In some exemplary embodiments of a carrying case, the first panel 10 and the second panel 20 are substantially rectangular planar shaped and are of substantially equal dimensions. The first panel 10 has a first panel inner surface and a first panel outer surface. Similarly, the second panel 20 has a second panel inner surface and a second panel outer surface. In some embodiments, the first panel 10 and the second panel 20 comprise any sturdy material such as wood, metal, glass, fiberglass, plastic, rubber, ethylene vinyl acetate, and/or polystyrene foam.

In some embodiments of a carrying case, the first panel outer surface displays an image 12 on a whiteboard material. In some embodiments, the whiteboard material comprises melamine, painted metal, glass, and/or ceramic. The image 12 may be one of a basketball court, a football field, a soccer field, or any other area for sporting events. The image 12 may include staffs for use in musical notation. A user such as a sports coach or a musician may use a dry erase marker to write or draw over the image 12.

In some embodiments, the second panel outer surface displays a second image on a second whiteboard material. The second image may be, for example, a half court image of a sports field or a player lineup.

In some other embodiments, the first panel outer surface displays a first half of an image and the second panel outer surface displays a second half of the image. A full image of the area is formed by joining the first half of the image with the second half of the image.

Some embodiments of a carrying case include a transparent sheet coupled over the first panel outer surface. The transparent sheet is configured to allow a dry erase marker to create marks upon it. This transparent sheet may be used if the first panel outer surface is unsuitable for dray erase marker use.

Some embodiments of a carrying case comprise at least one exterior marker cavity 18. The exterior marker cavity 18 may be in the shape of a dry-erase marker to allow a user to insert a dry-erase marker into the exterior marker cavity 18 by applying greater than a threshold amount of force towards the exterior marker cavity 18. The exterior marker cavity 18 may allow a user to remove the dry-erase marker from the exterior marker cavity 18 by applying greater than the threshold amount of force away from the exterior marker cavity 18.

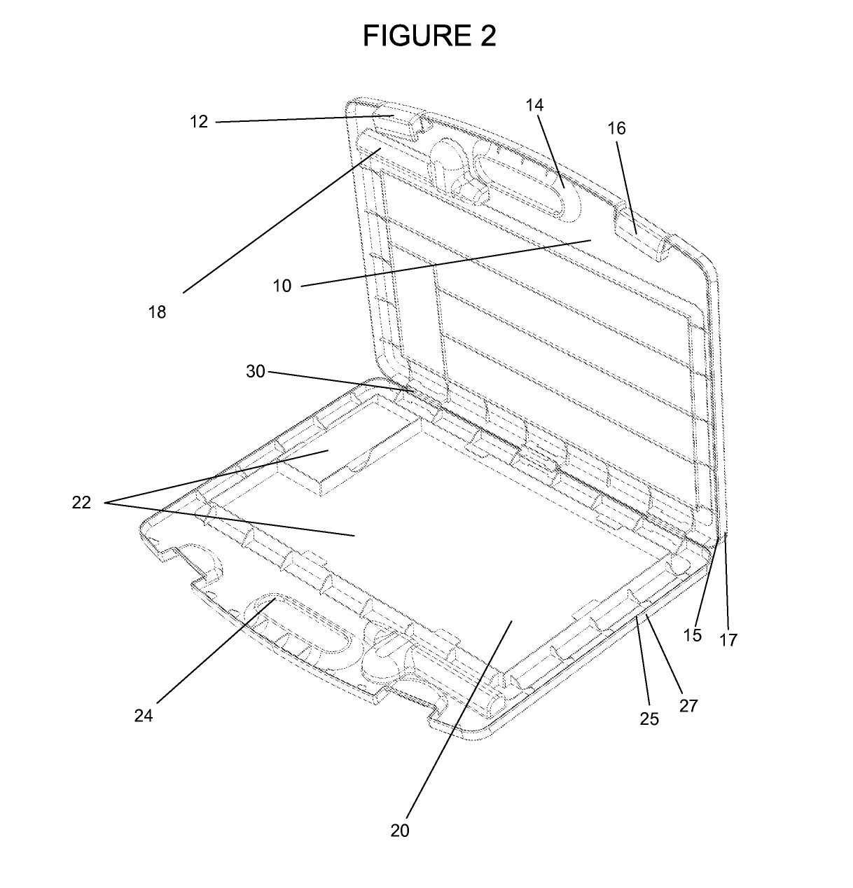

FIG. 2 illustrates an exemplary embodiment of a carrying case between a folded closed position and a folded open position. The carrying case comprises at least one hinge 30 rotatably coupling the first panel 10 to the second panel 20 along an axis. The hinge is configured to allow the first panel 10 and the second panel 20 to fold close and couple the first panel inner surface to the second panel inner surface. When in the folded closed position, the carrying case takes on a thicker rectangular planar shape from the first panel 10 stacked on top of the second panel 20. In some embodiments, the hinge 30 is also configured to allow the first panel 10 and the second panel 20 to fold open and align the first panel outer surface to the second panel outer surface. When in the folded open position, the carrying case takes on a thinner rectangular planar shape from the first panel 10 aligned end to end with the second panel 20.

In some embodiments of a carrying case, the hinge 30 may be a double hinged structure that includes two axis of rotation parallel to each other. The double hinged structure is rotatably coupled to the first panel 10 along the first axis of rotation. The double hinged structure is rotatably coupled to the second panel 20 along the second axis of rotation. In some other embodiments, there may be only one axis of rotation on the hinge 30.

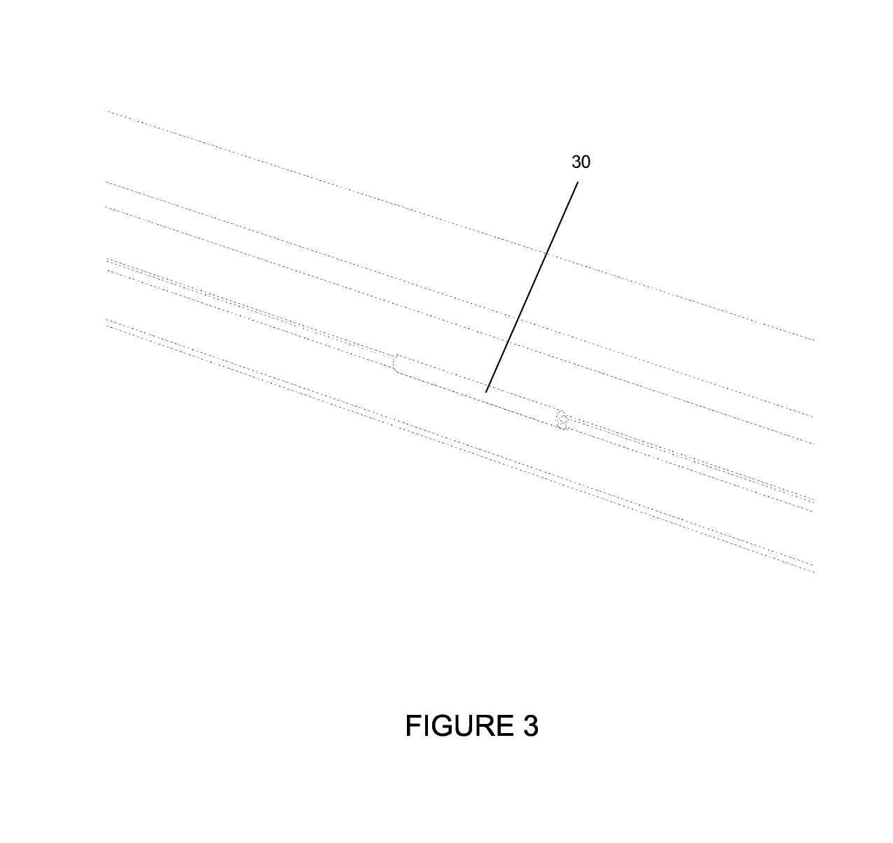

FIG. 3 illustrates a hinge on an exemplary embodiment of a carrying case. In some embodiments of a carrying case, the hinge 30 may comprise of a flexible material coupling the first panel 10 with the second panel 20. The hinge 30 comprising the flexible material may allow the carrying case to switch between the folded open position and the folded open position.

In some embodiments of a carrying case, the first panel inner surface may be secured against the second panel inner surface in a folded closed position by at least one latch 16. The latch 16 may be a flexible hook-like extension from the first panel 10 which is configured to catch onto an edge of the second panel 20 when the carrying case is in the folded closed position. The latch 16 may be peeled away from the edge of the second panel 20 to reopen the carrying case.

In some embodiments of a carrying case, the first panel inner surface and the second panel inner surface are configured to create storage compartments 22 when the first panel 10 and the second panel 20 are folded closed. The storage compartments 22 may be configured to be any size and shape within the confines of the perimeter of the first panel 10 and the second panel 20. The storage compartments 22 may be used to carry and store many types of accessories and tools such as dry erase markers, notepads, and pens.

In some embodiments of a carrying case, the first panel has a first handle cavity 14 and the second panel has a second handle cavity 24. The first handle cavity 14 may have substantially identical dimensions as the second handle cavity 24. In some embodiments, the first handle cavity and the second handle cavity are configured to be large to allow a user's hand to grasp the carrying case through the first handle cavity 14 and the second handle cavity 24 when the carrying case is in the folded closed position.

In some embodiments of a carrying case, the first panel 10 has a vertically extending border with an outer layer 17 and an inner layer 15, where the first panel outer layer 17 and the first panel inner layer 15 have different heights. The second panel may also have a vertically extending border with an outer layer 27 and an inner layer 25, where the second panel outer layer 27 and the second panel inner layer 25 have different heights. In some embodiments, the first panel outer layer 17 and the second panel inner layer 25 are configured to overlap when the first panel 10 and the second panel 20 are folded closed. There, the first panel inner layer 15 and the second panel outer layer 27 are also configured to overlap when the first panel 10 and second panel 20 are folded closed. This configuration allows the first panel 10 and the second panel 20 to have a more secure seal when folded closed. This configuration prevents small items such as pellets or thin items such as paper and coins from falling out of the carrying case when folded closed.

1. A carrying case, comprising:
a first panel comprising a first panel outer surface and a first panel inner surface, wherein said first panel outer surface includes a whiteboard material configured to display an image, and said first panel inner surface includes a first interior cavity created by a first vertical boarder extending inwards from said first panel outer surface;
an exterior cavity configured to hold a dry erase marker on said first panel outer surface adjacent to said whiteboard material, wherein said dry erase marker is useable to write over said image on said whiteboard material;
a second panel comprising a second panel outer surface and a second panel inner surface, wherein said second panel inner surface includes a second interior cavity created by a second vertical boarder extending inwards from said second panel outer surface; and
at least one hinge rotatably coupling said first panel to said second panel along an axis, wherein said hinge is configured to allow said first panel and said second panel to fold close and couple said first panel inner surface to said second panel inner surface thereby forming a storage compartment comprising said first interior cavity and said second interior cavity.

2. The carrying case of claim 1, wherein said first vertical border comprises an outer layer and an inner layer with different heights, and, wherein said second vertical border comprises an outer layer and an inner layer with different heights.

3. The carrying case of claim 1, wherein said second panel outer surface comprises a second whiteboard material configured to display a second image.

4. The carrying case of claim 1, wherein said first panel comprise a first handle cavity, and wherein said second panel comprise a second handle cavity.

5. (canceled)

6. (canceled)

7. The carrying case of claim 1, additionally comprising a transparent sheet coupled over said first panel outer surface, wherein said transparent sheet is configured to allow a dry erase marker to create marks upon said transparent sheet.

8. The carrying case of claim 1, where said first panel comprises at least one hinged latch configured to removably couple to a latch receiver on said second panel.

9. The carrying case of claim 1, wherein said first panel and said second panel comprise wood, metal, glass, fiberglass, plastic, rubber, ethylene vinyl acetate, and/or polystyrene foam.

10. The carrying case of claim 1, wherein said whiteboard material comprises melamine, painted metal, glass, and/or ceramic.

11. The carrying case of claim 1, wherein said first panel and said second panel are substantially rectangular planar shaped.

12. A carrying case, comprising:
a first panel comprising a first panel outer surface and a first panel inner surface, wherein said first panel outer surface displays a first image on a first whiteboard material;
a first exterior cavity configured to hold a first dry erase marker on said first panel outer surface adjacent to said first whiteboard material;
a second panel comprising a second panel outer surface and a second panel inner surface, wherein said second panel outer surface displays a second image on a second whiteboard material; and
a second exterior cavity configured to hold a second dry erase marker on said second panel outer surface adjacent to said second whiteboard material, wherein said first and said second dry erase markers are useable to write over said first or second image;
at least one hinge rotatably coupling said first panel to said second panel along an axis, wherein said hinge is configured to allow said first panel and said second panel to fold close and couple said first panel inner surface to said second panel inner surface.

13. The carrying case of claim 12, wherein said first panel comprises a vertically extending border with an outer layer and an inner layer with different heights, wherein said second panel comprises a vertically extending border with an outer layer and an inner layer with different heights.

14. The carrying case of claim 12, wherein said first panel comprise a first handle cavity, and wherein said second panel comprise a second handle cavity.

15. The carrying case of claim 12, wherein said first panel inner surface and said second panel inner surface are configured to create storage compartments when said first panel and said second panel are folded closed.

16. (canceled)

17. The carrying case of claim 12, additionally comprising a transparent sheet coupled over said first panel outer surface, wherein said transparent sheet is configured to allow a dry erase marker to create marks said transparent sheet.

18. The carrying case of claim 12, where said first panel comprises at least one hinged latch configured to removably couple to a latch receiver on said second panel.

19. The carrying case of claim 12, wherein said first panel and said second panel comprise wood, metal, glass, fiberglass, plastic, rubber, ethylene vinyl acetate, and/or polystyrene foam.

20. The carrying case of claim 12, wherein said first whiteboard material and said second whiteboard material comprises melamine, painted metal, glass, and/or ceramic.
